(19) United States
(12) Patent Application Publication
(10) Pub. No.: US 2025/0155545 A1
(43) Pub. Date: May 15, 2025

(54) ANCHOR PLACEMENT IN POSITIONING SYSTEMS

(71) Applicant: Samsung Electronics Co., Ltd., Suwon-si (KR)

(72) Inventors: Hossein Najaf-Zadeh, Prosper, TX (US); Jae Son, Plano, TX (US); Mark Trayer, Allen, TX (US); Djordje Preradovic, Oakland, MI (US); Gabriel Montenegro, Bradenton, FL (US); Clint Chaplin, San Jose, CA (US)

(21) Appl. No.: 18/940,783

(22) Filed: Nov. 7, 2024

Related U.S. Application Data
(60) Provisional application No. 63/598,901, filed on Nov. 14, 2023.

(51) Int. Cl. G01S 5/14

(52) U.S. Cl. CPC G01S 5/14; G01S 2205/02

(57) ABSTRACT

Methods and systems for anchor placement in positioning systems using wireless technology. A computer-implemented method includes receiving a signal an access points (AP) including one or more anchor coordinates of an anchor, converting the anchor coordinates into an anchor matrix, generating a positioning error using a condition number of the anchor matrix, determining whether the positioning error exceeds a predetermined threshold, upon determining that the positioning error exceeds the predetermined threshold, reducing the condition number of the anchor matrix by decomposing the anchor matrix using a singular value decomposition (SVD) process to generate a decomposed condition number, using the decomposed condition number to generate a decomposed anchor matrix, and determining a location for the anchor in a target 3-dimensional (3D) space based on the decomposed anchor matrix.

### CROSS-REFERENCE TO RELATED APPLICATIONS AND CLAIM OF PRIORITY

The present application claims priority to U.S. Provisional Patent Application No. 63/598,901, filed on Nov. 14, 2023. The contents of the above-identified patent documents are incorporated herein by reference.

### TECHNICAL FIELD

The present disclosure relates generally to wireless communication systems. more specifically, the present disclosure relates to a system and method for anchor placement in positioning systems using wireless technology.

### BACKGROUND

Location based services are increasingly being used to locate target objects such as other people, warehouse inventory, equipment, and the like. Accurate positioning of target objects is an essential part of location-based services. In outdoor environments, accurate positioning can be performed using a global positioning systems (GPS). However, outdoor positioning systems may fail in indoor environments due to the lack of (or a very weak) GPS signal. For indoor positioning, a wireless positioning system, e.g., Ultra-Wideband (UWB) or Wi-Fi positioning, is desirable due to low energy consumption. Yet, the performance of a wireless positioning system is degraded by errors in received anchor coordinates.

### SUMMARY

The present disclosure relates generally to wireless communication systems and, more specifically, the present disclosure relates to a system and method for anchor placement in positioning systems using wireless technology.

In one embodiment, a computer-implemented method is provided. The computer-implemented method includes receiving a signal from an access point (AP) including one or more anchor coordinates of an anchor, converting the one or more anchor coordinates into an anchor matrix, generating a positioning error using a condition number of the anchor matrix, determining whether the positioning error exceeds a predetermined threshold, upon determining that the positioning error exceeds the predetermined threshold, reducing the condition number of the anchor matrix by decomposing the anchor matrix using a singular value decomposition (SVD) process to generate a decomposed condition number, using the decomposed condition number to generate a decomposed anchor matrix, and determining a location for the anchor in a target 3-dimensional (3D) space based on the decomposed anchor matrix.

In another embodiment, an electronic device is provided. The electronic device includes a transceiver configured to receive a signal based on which a tag distance corresponding to a distance of a tag from the respective anchor is identified, and a processor operably coupled to the transceiver, configured to receive a signal from an access point including one or more anchor coordinates of an anchor, convert the one or more anchor coordinates into an anchor matrix, generate a positioning error using a condition number of the anchor matrix, determine whether the positioning error exceeds a predetermined threshold, upon determining that the positioning error exceeds the predetermined threshold, reduce the condition number of the anchor matrix by decomposing the anchor matrix using a singular value decomposition (SVD) process to generate a decomposed condition number, use the decomposed condition number to generate a decomposed anchor matrix, and determine a location for the anchor in a target 3-dimensional (3D) space based on the decomposed anchor matrix.

In yet another embodiment, a non-transitory computer-readable medium is provided. The non-transitory computer-readable medium includes program code, that when executed by at least one processor of an electronic device, causes the electronic device to receive a signal from an access point including one or more anchor coordinates of an anchor, convert the one or more anchor coordinates into an anchor matrix, generate a positioning error using a condition number of the anchor matrix, determine whether the positioning error exceeds a predetermined threshold, upon determining that the positioning error exceeds the predetermined threshold, reduce the condition number of the anchor matrix by decomposing the anchor matrix using a singular value decomposition (SVD) process to generate a decomposed condition number, use the decomposed condition number to generate a decomposed anchor matrix, and determine a location for the anchor in a target 3-dimensional (3D) space based on the decomposed anchor matrix.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example access point according to various embodiments of the present disclosure;

FIG. 2B illustrates an example station according to various embodiments of this disclosure;

FIG. 3 illustrates an example positioning system performing anchor placement in an environment according to various embodiments of the present disclosure;

FIG. 4 illustrates an example positioning system of an indoor location-based service according to embodiments of the present disclosure; and

FIG. 5 illustrates an example method of tag location determination according to embodiments of the present disclosure.

### DETAILED DESCRIPTION

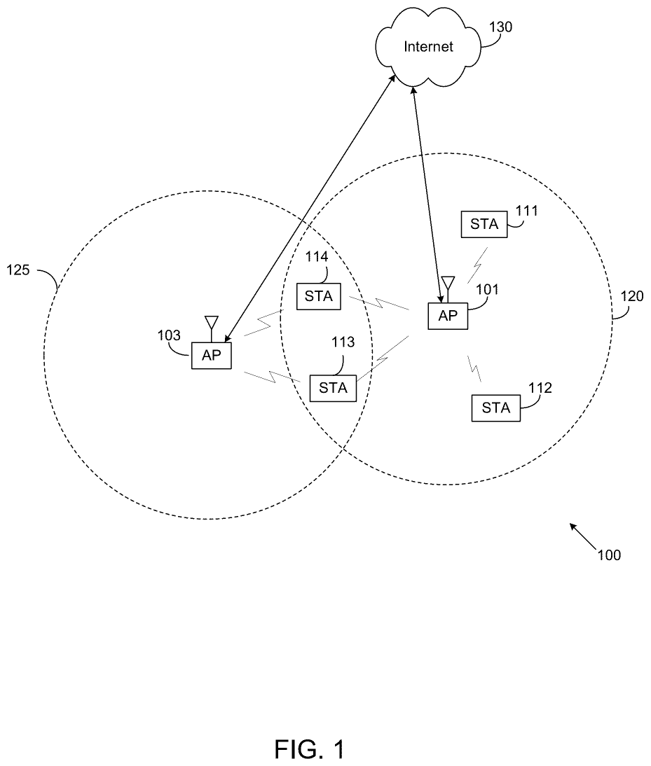

FIG. 1 through FIG. 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, location-based services are increasingly being used to locate target objects such as other people, warehouse inventory, equipment, and the like. Accurate positioning of target objects is an essential part of location-based services. For indoor positioning, a wireless positioning system, e.g., Ultra-Wideband (UWB) or Wi-Fi positioning, may be desirable due to low energy consumption. Yet, the performance of a wireless positioning system is degraded by errors in received anchor coordinates.

Accordingly, the present disclosure provides systems and methods for wireless user velocity tracking. As described herein, the present disclosure includes a computer implemented method that reduces errors propagated through a tag positioning process by adjusting received anchor coordinates, in an anchor matrix, using a singular value decomposition process and a condition number. The methods also include incorporating constraints correlated to a physical limitation, e.g., the architecture of a room, to further reduce errors in tag positioning.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111, 112, 113, and 114 within a coverage area 120 of the AP 101. The APs 101-103 may communicate with each other and with the STAs 111-114 using Wi-Fi, Ultra-Wide Band (UWB), or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for estimating a user velocity based on multi-antenna WiFi signals in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

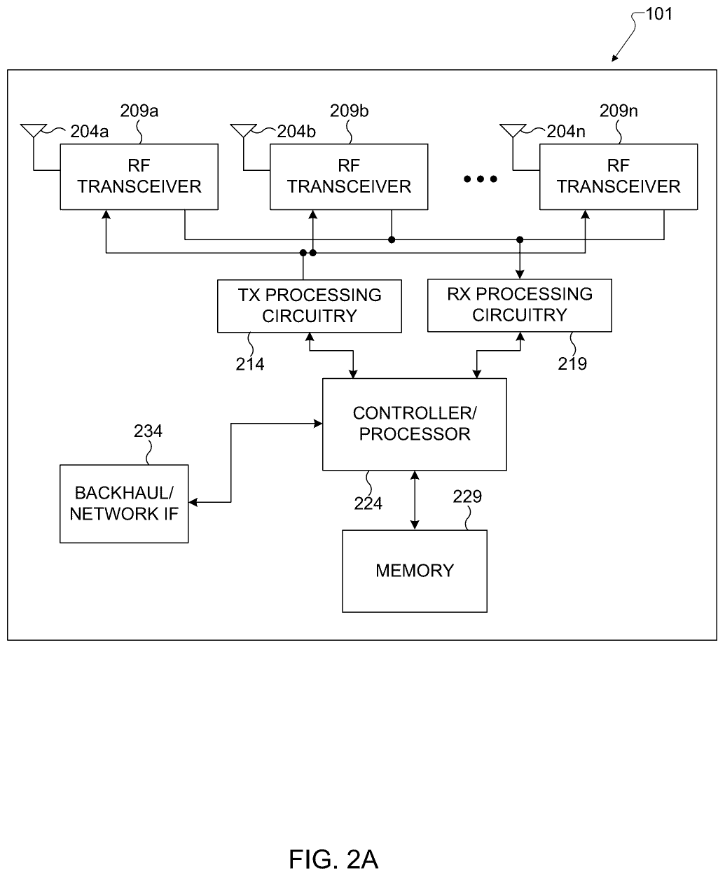

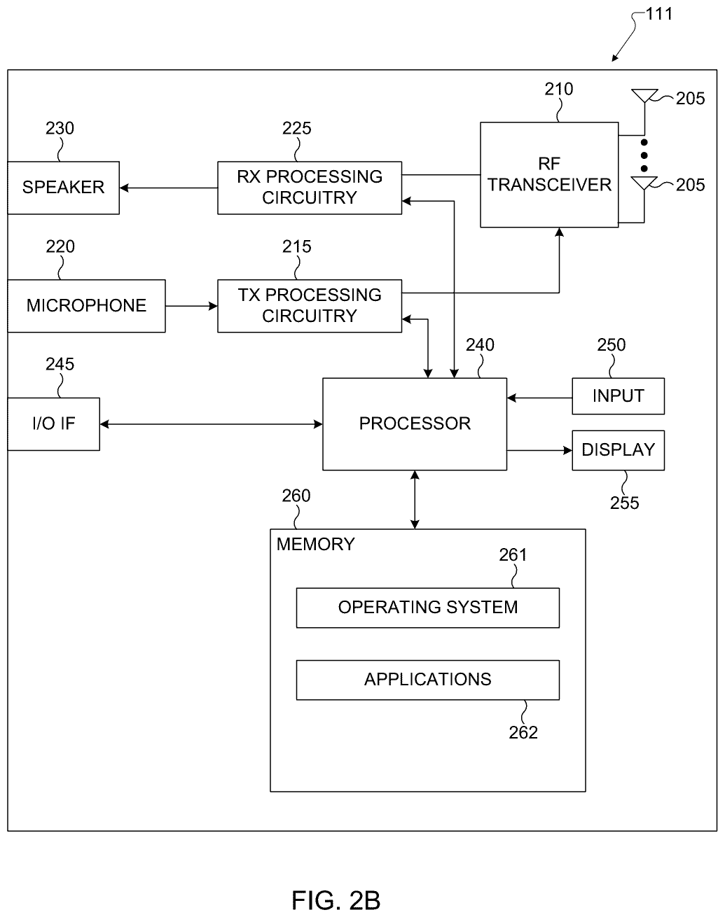

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n, multiple RF transceivers 209a-209n, transmitter processing circuitry 214, and receiver processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the receiver processing circuitry 219, which generates processed baseband signals by filtering, decoding, and/or digitizing the baseband or IF signals. The receiver processing circuitry 219 transmits the processed baseband signals to the controller/processor 224 for further processing.

The transmitter processing circuitry 214 receives analog or digital data (such as voice data, web data, e-mail, or interactive video game data) from the controller/processor 224. The transmitter processing circuitry 214 encodes, multiplexes, and/or digitizes the outgoing baseband data to generate processed baseband or IF signals. The RF transceivers 209a-209n receive the outgoing processed baseband or IF signals from the transmitter processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the receiver processing circuitry 219, and the transmitter processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including estimating a user velocity based on multi-antenna WiFi signals. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for estimating a user velocity based on multi-antenna WiFi signals. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of transmitter processing circuitry 214 and a single instance of receiver processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, a radio frequency (RF) transceiver 210, transmitter processing circuitry 215, a microphone 220, and receiver processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the receiver processing circuitry 225, which generates a processed baseband signal by filtering, decoding, and/or digitizing the baseband or IF signal. The receiver processing circuitry 225 transmits the processed baseband signal to the speaker 230 (such as for voice data) or to the controller/processor 240 for further processing (such as for web browsing data).

The transmitter processing circuitry 215 receives analog or digital voice data from the microphone 220 or other outgoing baseband data (such as web data, e-mail, or interactive video game data) from the controller/processor 240. The transmitter processing circuitry 215 encodes, multiplexes, and/or digitizes the outgoing baseband data to generate a processed baseband or IF signal. The RF transceiver 210 receives the outgoing processed baseband or IF signal from the transmitter processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the receiver processing circuitry 225, and the transmitter processing circuitry 215 in accordance with well-known principles. In some embodiments, the controller/processor 240 includes at least one microprocessor or microcontroller.

The controller/processor 240 is also capable of executing other processes and programs resident in the memory 260, such as operations for determining a position of a tag based on anchor signals. The controller/processor 240 can move data into or out of the memory 260 as required by an executing process. In some embodiments, the controller/processor 240 is configured to execute a plurality of applications 262. The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

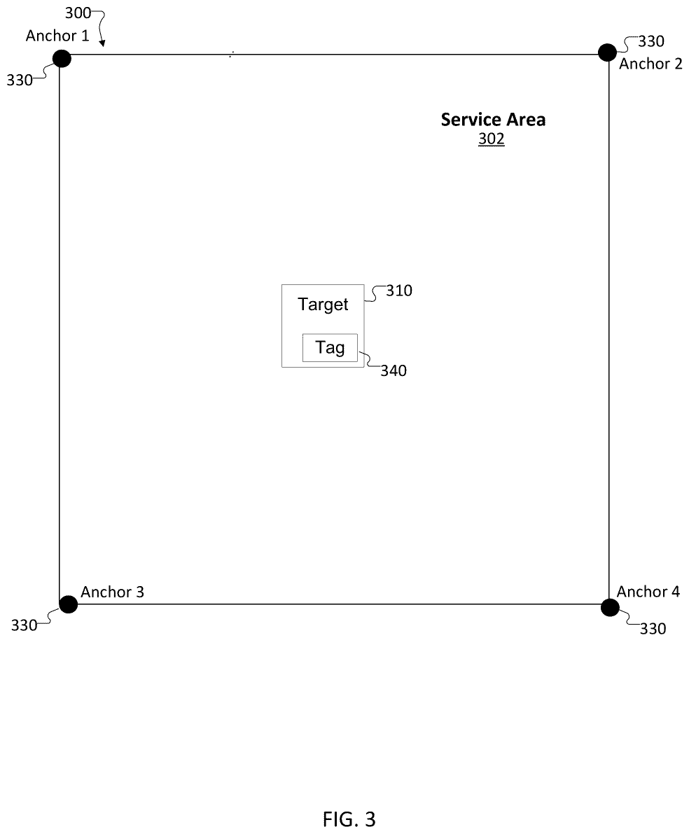

FIG. 3 illustrates an example system 300 in which wireless positioning anchor locations can be determined for service areas of an indoor location-based service according to embodiments of the present disclosure. For ease of explanation, the system 300 will be described as including one or more components of the wireless network 100 of FIG. 1, such as the STAs 111-114; however, the system 300 could be implemented using any other suitable device or system. The embodiment of the system 300 shown in FIG. 3 is for illustration only. Other embodiments of the system 300 could be used without departing from the scope of this disclosure.

As shown in FIG. 3, the system 300 includes a service area 302, a target object 310, and multiple anchors 330.

The service area 302 is a geographical area in which a location-based service identifies target objects. In the system 300, the service area 302 represents an indoor space in which the target object 310 may be located.

The target object 310 is an object that can be located by a location-based service of the service area 302 to the system 300. In some embodiments, the target object 310 is a personal consumer device, such as a smart phone or tablet. The target object 310 may represent (or be represented by) one of the STAs 111-114.

The anchors 330 include UWB sensors (or other types of RF sensors) and are placed in fixed locations throughout the service area 302 to provide reference for localization and for determining the service area 302. To generate unique reference about the localization, the system 300 may include three or more anchors 330, as described in greater detail below.

Target object 310 can include one or more tags 340. The tags 340 are wireless transmitters (for example UWB sensors) that are installed in (or otherwise connected to) the target object 310 and enable wireless communication with the anchors 330. In wireless based localization, the tags 340 are used to localize the target object 310 in the environment using the reference information provided by the anchors 330. In some embodiments, the target object 310 may not include a built-in tag 340 (such as when the target object 310 is a smart phone or tablet that is not configured for UWB or other communication used in wireless positioning systems).

The anchor 330 may include a UWB module (not shown) or other type of RF sensor that enables wireless communication with the target object 310. The anchor 330 may also include a secondary RF module that can be used to create a secondary wireless network for communication of data and commands between the anchors 330 and the tags 340. Consequently, the devices containing the tags 340 (e.g., the target object 310) also contain compatible RF modules. In one embodiment, the secondary RF modules are Bluetooth Low Energy (BLE) modules. Other embodiments may employ a secondary Wi-Fi network for the communication of data and commands between the anchors 330 and the tags 340.

Although FIG. 3 illustrates one example of a wireless positioning system, various changes may be made to FIG. 3. For example, a different quantity of anchors may be utilized, the target object may be an object other than an electronic device, etc.

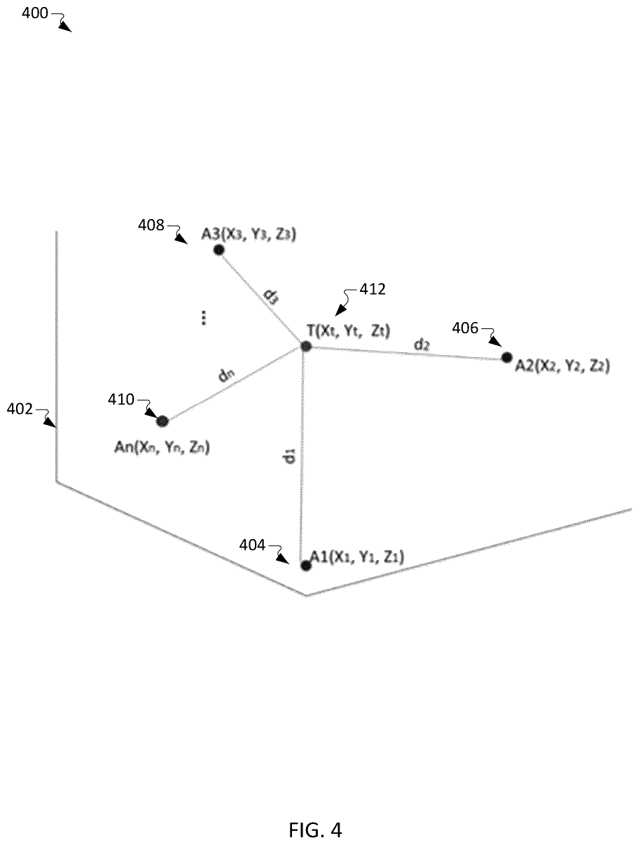

To generate a unique reference about the localization of a tag, the system may use a plurality of anchors with known positions. An example method of localization of a tag utilizing three anchors is further described regarding FIG. 4.

FIG. 4 illustrates an example system 400 in which wireless positioning anchor locations can be determined for service areas of an indoor location-based service according to embodiments of the present disclosure. The embodiment of the system 400 shown in FIG. 4 is for illustration only. Other embodiments of the system 400 could be used without departing from the scope of this disclosure.

In the example of FIG. 4, four wireless anchors 404, 406, 408, and 410 located at (X₁, Y₁, Z₁), (X₂, Y₂, Z₂), (X₃, Y₃, Z₃), and (X_{N}, Y_{N}, Z_{N}), respectively, are used to locate a tag 412 in a 3-dimensional (3D) space 402. Although four anchors are shown, any desired number of anchors may be used, such as one or more, such as two or more, such as three or more, such as five or more. The distance of the tag 412 from the anchors 404, 406, 408, and 410 may be found as follows:

$${d}_{i}^{2} = {( {x}_{i} - {x}_{t} )}^{2} + {( {y}_{i} - {y}_{t} )}^{2} + {( {z}_{i} - {z}_{t} )}^{2} , i = 1 , … , N$$

For the sake of simplicity, without loss of generality, assume that anchor 404 is located at (0, 0, 0):

$${d}_{1}^{2} = {x}_{t}^{2} + {y}_{t}^{2} + {z}_{t}^{2}$$

Subtracting dᵢ² from d₁²,

$${d}_{i}^{2} - {d}_{1}^{2} = {x}_{i}^{2} - 2 {x}_{i} {x}_{t} + {y}_{i}^{2} - 2 {y}_{i} {y}_{t} + {z}_{i}^{2} - 2 {z}_{i} {z}_{t} , i = 2 , … , N$$

Define rᵢ² as follows:

$${r}_{i}^{2} = {x}_{i}^{2} + {y}_{i}^{2} - 2 {y}_{i} {y}_{t} + {z}_{i}^{2} - 2 {z}_{i} {z}_{t} , i = 2 , … , N$$

This results in the following:

$${d}_{i}^{2} - {d}_{1}^{2} = {r}_{i}^{2} - 2 {x}_{i} {x}_{t} - 2 {y}_{i} {y}_{t} - 2 {z}_{i} z , i = 2 , … , N$$

Written in a matrix form:

$$( \begin{matrix}{x}_{2} & {y}_{2} & {z}_{2} \\ ⋮ & ⋮ & ⋮ \\ {x}_{N} & {y}_{N} & {z}_{N}\end{matrix} ) ( \begin{matrix}{x}_{t} \\ {y}_{t} \\ {z}_{t}\end{matrix} ) = ( \begin{matrix}{r}_{2}^{2} - {d}_{2}^{2} + {d}_{1}^{2} \\ ⋮ \\ {r}_{N}^{2} - {d}_{N}^{2} + {d}_{1}^{2}\end{matrix} )$$

Define the following matrix and vectors:

$$A = ( \begin{matrix}{x}_{2} & {y}_{2} & {z}_{2} \\ ⋮ & ⋮ & ⋮ \\ {x}_{N} & {y}_{N} & {z}_{N}\end{matrix} ) ,$$

$$D = ( \begin{matrix}{r}_{2}^{2} - {d}_{2}^{2} + {d}_{1}^{2} \\ ⋮ \\ {r}_{N}^{2} - {d}_{N}^{2} + {d}_{1}^{2}\end{matrix} ) , and$$

$$T = ( \begin{matrix}{x}_{t} \\ {y}_{t} \\ {z}_{t}\end{matrix} )$$

where matrix A contains the coordinates of the anchors404, 406, 408, and 410, and T is the position of the tag 412 in the 3D space 402.

Depending on the dimensions and rank of matrix A, the position of the tag 412 may or may not be found. For example, if the anchor matrix A is a 2×3 matrix, the system of equations is under-determined, meaning that there are an infinite number of solutions, unless some constraints are imposed to the position of the tag 412. If the anchor matrix A is a 3×3 matrix, and with rank 3, the position of the tag 412 can be determined uniquely as follows:

$$T = {A}^{- 1} D$$

If the anchor matrix A is a N×3 matrix where N>3, and with rank 3, the system of equations is over-determined, and the best position of the tag 412 can be determined via a least square minimization as follows:

T=pinv(A)D

where pinv (A) indicates the pseudo-inverse of the anchor matrix A.

The position of a tag can be found if the anchor matrix A is full rank. However, due to errors in the coordinates of the anchors 404, 406, 408, and 410 as well as errors in the distance measurement, there might be significant errors in the tag positioning. As tag positioning uses inverse (or pseudo-inverse) of the anchor matrix A, e.g., inverse anchor matrix A⁻¹ and pseudo-inverse anchor matrix pinv (A), which are sensitive to errors in the anchor matrix A. The sensitivity of the inverse anchor matrix A⁻¹ and the pseudo-inverse anchor matrix pinv (A) is proportional to the condition number of the anchor matrix A as shown below.

An error matrix E_{A} may be added to the anchor matrix A. The error matrix E_{A} will cause an error matrix E_{invA} in the inverse anchor matrix A⁻¹. For example,

$$( {A}^{- 1} + {E}_{i n v A} ) ( A + {E}_{A} ) = I ,$$

where I is the unity matrix. Further, assuming E_{invA} E_{A} is negligible:

$${A}^{- 1} {E}_{A} + {E}_{i n v A} A = 0$$

$$and$$

$${E}_{i n v A} = {A}^{- 1} {E}_{A} {A}^{- 1} .$$

The matrix norm from both sides, e.g., for two matrices M₁ and M₂, the inequality holds

∥M₁ M₂∥≤∥M₁∥∥M₂∥,

∥E_{invA}∥≤∥A⁻¹∥∥E_{A}∥∥A⁻¹∥,

and finally,

$$\frac{‖ {E}_{i n v A} ‖}{‖ {A}^{- 1} ‖} \leq ‖ {A}^{- 1} ‖ ‖ A ‖ \frac{‖ {E}_{A} ‖}{‖ A ‖} ,$$

where ∥A⁻¹∥ ∥ A∥ is the condition number K(A) of the anchor matrix A. The condition number K(A) of the anchor matrix is defined as the ratio of its largest to smallest singular values.

The sensitivity of the inverse anchor matrix A⁻¹ is proportional to the condition number K(A) of matrix A. Thus, any errors in the anchor matrix A will propagate errors proportional to K(A) in the inverse anchor matrix A⁻¹. For example, if the condition number K(A) is large, a relatively small error in matrix A will result in large errors in the inverse anchor matrix A⁻¹, significantly impacting the accuracy of the tag positioning. Additionally, small errors in the distance vector D, which includes the measured distances between the tag and the anchors, will be increased by the large error in the inverse anchor matrix A⁻¹, further deteriorating the accuracy of tag positioning.

To obtain more accurate tag positioning, the condition number K(A) of the anchor matrix A may be reduced. To reduce the condition number K(A), in matrix A is decomposed using singular value decomposition, given as:

A=USV′

where matrix S is a diagonal matrix that contains the singular values of matrix A on its diagonal. Adding a positive value c to the smallest singular value of matrix S will lower the condition number K(A) of the anchor matrix A:

$${S}_{2} ( 3 , 3 ) = S ( 3 , 3 ) + c ,$$

$$then ,$$

$${A}_{2} = U {S}_{2} {V}^{′} .$$

The larger the value of the positive value c, e.g., as long as S₂(3,3) is not larger than the second smallest singular value of matrix S, e.g., S₂(2,2), the more reduced the condition number of a decomposed anchor matrix A₂ will be. For example, anchor A₁ may be located at (0, 0, 0), the new coordinates of other anchors will be the rows of the decomposed anchor matrix A₂. The anchors may be moved to the new locations, e.g., by the user or by other means.

If the anchor locations are limited by the physical architecture of the 3D space 402, the new coordinates for the anchors may be adjusted. However, the condition number K(A) of matrix A₂ should not become too large, e.g., thereby limiting the subsequent anchor coordinates to within the architectural limitations of the 3D space 402.

Location of anchors can be found via an optimization procedure. The coordinates of the anchors are included in matrix A, assuming that anchor 404 is located at the origin of the coordinate system. For example, the coordinates of anchors 406, 408, and 410 may be found to minimize the condition number K(A) of the decomposed matrix A₂:

min K(A).

The optimization is not constrained and will find a decomposed anchor matrix of coordinates with the condition number K(A)=1. This matrix may have the coordinates of the anchors at unacceptable locations due to limitation in the 3D space 402, e.g., limitations imposed by the room architecture. As such, a constraint {Cᵢ} may be added to the optimization procedure, e.g., to the condition number K(A) to find the anchors locations within the limits of the 3D space 402:

$${min K ( A )}_{s . t . \{ {C}_{i} \}} .$$

The constraints {Cᵢ} can be imposed by the geometry of the space, e.g. limited height, or any other limitations, e.g. all anchors located in the first octant in the 3D coordinate system such that there are only positive coordinates.

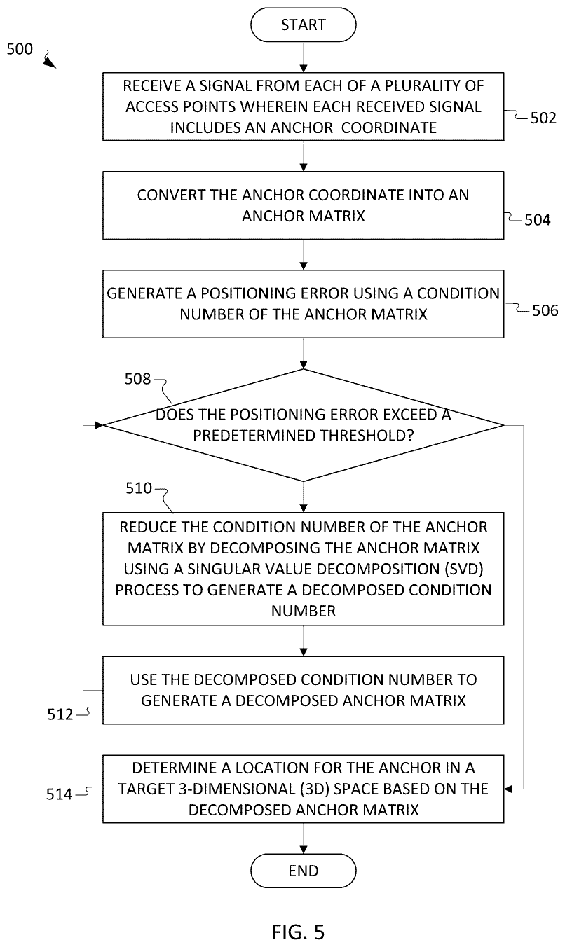

FIG. 5 illustrates an example tag location determination method 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of tag location determination could be used without departing from the scope of this disclosure.

As illustrated in FIG. 5, the method 500 begins at step 502. At step 502, a receiving a signal from each of a plurality of access points. The signal includes anchor coordinates of an anchor. For example, a transceiver of an electronic device may be configured to receive from each of a plurality of anchors, a signal based on which a tag distance corresponding to a distance of a tag from the respective anchor is identified.

At step 504, the anchor coordinates are converted into an anchor matrix. For example, the anchor coordinates may be placed into matrix form, e.g., a 3×3 matrix including x-coordinates, y-coordinates, and z-coordinates for each anchor coordinate, by a processor coupled to the transceiver of an electronic device. At step 506, a positioning error may be generated using a condition number of the anchor matrix A. For example, if the coordinates of an anchor are known or if the coordinates exceed a constraint of the 3D space, the condition number of the anchor matrix A may be defined as the ratio of its largest to smallest singular values of the anchor matrix A.

At step 508, determining whether the positioning error exceeds a predetermined threshold. For example, the predetermined threshold may be a percentage of acceptable positioning error, e.g., 10% of a deviation from a stored known anchor position in the 3D space. If the positioning error does not exceed the predetermined threshold, the method 500 proceeds to step 514 as described below.

At step 510, upon determining that the positioning error exceeds the predetermined threshold, the condition number of the anchor matrix is reduced by decomposing the anchor matrix using a singular value decomposition (SVD) process to generate a decomposed condition number. For example, decomposing the anchor matrix may include using a diagonal matrix including the singular values of the anchor matrix ordered from the largest singular value to the smallest singular value. Reducing the condition number may then include increasing the smallest singular value or reducing the largest singular value of the anchor matrix. For example, increasing the smallest singular value includes adding a positive value that is less than a second smallest singular value such that the smallest singular value does not exceed the second smallest singular value after the addition of the positive value. Additionally, decreasing the largest singular value includes adding a negative value that is less than a difference between the largest singular value and a second largest singular value such that the largest singular value is not less than the second largest singular value after the addition of the negative value.

At step 512, the decomposed condition number may be used to generate a decomposed anchor matrix. Additionally, the decomposed anchor matrix may include a constraint based on an architectural limitation of the 3D space 402. The constraint may be imposed by a geometry of the 3D space 402, e.g. limited height, or any other constraints, e.g. all anchors located in the first octant in the 3D coordinate system such that there are only positive coordinates.

At step 514, a location for the anchor in the 3D space 402 is determined based on the decomposed anchor matrix. For example, the location of the anchor may be found using an optimization procedure. The coordinates of the anchors are included in matrix A, assuming that anchor A₁ is located at the origin of the coordinate system. For example, the coordinates of anchors A₂, . . . , A_{N} may be found to minimize the condition number of the decomposed matrix K(A).

Although FIG. 5 illustrates one example tag location determination method 500, various changes may be made to FIG. 5. For example, while shown as a series of steps, various steps in FIG. 5 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving a signal from an access point (AP) including one or more anchor coordinates of an anchor;
converting the one or more anchor coordinates into an anchor matrix;
generating a positioning error using a condition number of the anchor matrix;
determining whether the positioning error exceeds a predetermined threshold;
upon determining that the positioning error exceeds the predetermined threshold, reducing the condition number of the anchor matrix by decomposing the anchor matrix using a singular value decomposition (SVD) process to generate a decomposed condition number;
using the decomposed condition number to generate a decomposed anchor matrix; and
determining a location for the anchor in a 3-dimensional (3D) space based on the decomposed anchor matrix.

2. The method of claim 1, wherein the anchor matrix comprises singular values based on the one or more anchor coordinates of the anchor.

3. The method of claim 2, wherein the condition number of the anchor matrix is a ratio of a largest singular value to a smallest singular value of the anchor matrix.

4. The method of claim 2, wherein decomposing the anchor matrix comprises using a diagonal matrix including the singular values of the anchor matrix ordered from the largest singular value to the smallest singular value.

5. The method of claim 2, wherein reducing the condition number comprises increasing the smallest singular value or reducing the largest singular value of the anchor matrix.

6. The method of claim 5, wherein increasing the smallest singular value comprises adding a positive value that is less than a second smallest singular value such that the smallest singular value does not exceed the second smallest singular value after adding the positive value.

7. The method of claim 5, wherein decreasing the largest singular value comprises adding a negative value that is less than a difference between the largest singular value and a second largest singular value such that the largest singular value is not less than the second largest singular value after adding the negative value.

8. The method of claim 1, wherein the decomposed anchor matrix comprises a constraint based on an architectural limitation of the 3D space.

9. An electronic device, comprising:
a transceiver configured to receive a signal from an access point (AP) including one or more anchor coordinates of an anchor; and
a processor operably coupled to the transceiver, configured to:
convert the one or more anchor coordinates into an anchor matrix;
generate a positioning error using a condition number of the anchor matrix;
determine whether the positioning error exceeds a predetermined threshold;
upon determining that the positioning error exceeds the predetermined threshold, reduce the condition number of the anchor matrix by decomposing the anchor matrix using a singular value decomposition (SVD) process to generate a decomposed condition number;
use the decomposed condition number to generate a decomposed anchor matrix; and
determine a location for the anchor in a target 3-dimensional (3D) space based on the decomposed anchor matrix.

10. The electronic device of claim 9, wherein the anchor matrix comprises singular values based on the one or more anchor coordinates of the anchor.

11. The electronic device of claim 10, wherein the condition number of the anchor matrix is a ratio of a largest singular value to a smallest singular value of the anchor matrix.

12. The electronic device of claim 10, wherein the processor, when causing the electronic device to decompose the anchor matrix, is further configured to cause the electronic device to use a diagonal matrix including the singular values of the anchor matrix ordered from the largest singular value to the smallest singular value.

13. The electronic device of claim 12, wherein the processor, when causing the electronic device to reduce the condition number, is further configured to cause the electronic device to increase the smallest singular value or reducing the largest singular value of the anchor matrix.

14. The electronic device of claim 12, wherein the processor, when causing the electronic device to reduce the condition number, is further configured to cause the electronic device to add a positive value that is less than a second smallest singular value such that the smallest singular value does not exceed the second smallest singular value after adding the positive value.

15. A non-transitory computer-readable medium comprising program code, that when executed by at least one processor of an electronic device, causes the electronic device to:
receive a signal from an access point including one or more anchor coordinates of an anchor;
convert the one or more anchor coordinates into an anchor matrix;
generate a positioning error using a condition number of the anchor matrix;
determine whether the positioning error exceeds a predetermined threshold;
upon determining that the positioning error exceeds the predetermined threshold, reduce the condition number of the anchor matrix by decomposing the anchor matrix using a singular value decomposition (SVD) process to generate a decomposed condition number;
use the decomposed condition number to generate a decomposed anchor matrix; and
determine a location for the anchor in a target 3-dimensional (3D) space based on the decomposed anchor matrix.

16. The non-transitory computer-readable medium of claim 15, wherein the anchor matrix comprises singular values based on the one or more anchor coordinates of the anchor.

17. The non-transitory computer-readable medium of claim 16, wherein the condition number of the anchor matrix is a ratio of a largest singular value to a smallest singular value of the anchor matrix.

18. The non-transitory computer-readable medium of claim 17, wherein the program code, that when executed by the at least one processor, causes the electronic device to decompose the anchor matrix, further comprises program code, that when executed by the at least one processor, causes the electronic device to use a diagonal matrix including the singular values of the anchor matrix ordered from the largest singular value to the smallest singular value.

19. The non-transitory computer-readable medium of claim 18, wherein the program code, that when executed by the at least one processor, causes the electronic device to reduce the condition number, comprises program code, that when executed by the at least one processor, causes the electronic device to increase the smallest singular value or reducing the largest singular value of the anchor matrix.

20. The non-transitory computer-readable medium of claim 18, wherein the program code, that when executed by the at least one processor, causes the electronic device to reduce the condition number, comprises program code, that when executed by the at least one processor, causes the electronic device to add a positive value that is less than a second smallest singular value such that the smallest singular value does not exceed the second smallest singular value after adding the positive value.
